(19) United States
(12) Patent Application Publication
(10) Pub. No.: US 2016/0180442 A1
(43) Pub. Date: Jun. 23, 2016

(54) ONLINE RECOMMENDATIONS BASED ON OFF-SITE ACTIVITY

(71) Applicant: eBay Inc., San Jose, CA (US)

(72) Inventors: Matanya Bar, Tel Aviv (IL); Neelakantan Sundaresan, Mountain View, CA (US)

(21) Appl. No.: 14/579,970

(22) Filed: Dec. 22, 2014

(51) Int. Cl. G06Q 30/06

(52) U.S. Cl. CPC G06Q 30/0631

(57) ABSTRACT

A system and method of determining online recommendations based on off-site activity are disclosed. In some example embodiments, user input identifying at least one account of a first user is received, with each one of the account(s) being hosted by a corresponding online service independent of a first website. A link with the account(s) is established. Purchase history information of the first user is accessed from the account(s). A first pattern of purchasing activity for the first user is determined based on the purchase history information. A first recommendation is generated based on the determined first pattern. The first recommendation comprises a first content of the first website. A presentation time for the first recommendation is determined based on the determined first pattern. The first recommendation is caused to be presented to the first user on a first computing device at the determined presentation time.

### CROSS-REFERENCE TO RELATED APPLICATIONS

This application claims priority, under 35 U.S.C. Section 119(e), to U.S. Provisional Application No. 61/943,665, filed on Feb. 24, 2014, entitled, “WEBSITE MERCHANDISING BASED ON OFF-SITE PURCHASE HISTORY”, which is hereby incorporated by reference in its entirety as if set forth herein.

### TECHNICAL FIELD

The present application relates generally to the technical field of data processing, and, in various embodiments, to systems and methods of generating online recommendations based on off-site activity.

### BACKGROUND

Online recommendations are limited by the data available to the system generating the recommendations. Vast amounts of data are typically left out of the process for generating such recommendations, causing recommendations to fail to fulfill their full potential. Furthermore, there is a lack of development of technical features to handle the vast amounts of data that could be used in generating recommendations.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publication system, in accordance with some embodiments;

FIG. 3 is a block diagram depicting various tables that may be maintained within a database, in accordance with some embodiments;

FIG. 4 is a block diagram illustrating components of an environment for a recommendation system, in accordance with some embodiments;

FIG. 5 is a block diagram illustrating components of a recommendation system, in accordance with some embodiments;

FIG. 6 is a flowchart illustrating a method of providing recommendations, in accordance with some embodiments;

FIG. 7 is a flowchart illustrating a method of providing recommendations, in accordance with some embodiments;

FIG. 8 is a flowchart illustrating a method of providing recommendations, in accordance with some embodiments;

FIG. 9 is a flowchart illustrating a method of providing recommendations, in accordance with some embodiments;

FIG. 10 is a flowchart illustrating a method of providing recommendations, in accordance with some embodiments;

FIG. 11 is a flowchart illustrating a method of providing recommendations, in accordance with some embodiments;

FIG. 12 is a flowchart illustrating a method of providing recommendations, in accordance with some embodiments;

FIG. 13 is a flowchart illustrating a method of providing recommendations, in accordance with some embodiments;

FIG. 14 is a flowchart illustrating a method of determining a pattern of purchasing activity, in accordance with some embodiments;

FIG. 15 is a flowchart illustrating a method of providing recommendations, in accordance with some embodiments;

FIG. 16 is a flowchart illustrating a method of providing recommendations, in accordance with some embodiments;

FIG. 17 is a block diagram illustrating a mobile device, in accordance with some example embodiments; and

FIG. 18 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In some example embodiments, user input identifying at least one account of a first user is received, with each one of the account(s) being hosted by a corresponding online service independent of a first website. A link with the account(s) of the first user is established based on a user-generated interrupt corresponding to the user input. Purchase history information of the first user is accessed from the at least one account of the first user. A first pattern of purchasing activity for the first user is determined based on the purchase history information. A first recommendation for the first user is generated based on the determined first pattern of purchasing activity. The first recommendation comprises a first content of the first website. A presentation time for the first recommendation is determined based on the determined first pattern of purchasing activity. The first recommendation is caused to be presented to the first user on a first computing device at the determined presentation time.

In some example embodiments, the account(s) comprises at least one of an e-mail account of the first user, a credit card account of the first user, and an e-commerce account with an e-commerce website.

In some example embodiments, determining the pattern of purchasing activity comprises identifying repeated purchases of a same type of product based on the purchase history information, calculating a frequency of the repeated purchases, determining that the frequency of the repeated purchases satisfies a predetermined threshold value, and determining that the first pattern of purchasing activity comprises the repeated purchase of the same type of product. The first recommendation comprises a product recommendation of the same type of product on the first website, and the presentation time for the first recommendation is based on the frequency of the repeated purchases.

In some example embodiments, a second pattern of purchasing activity for the first user is determined based on the purchase history information. The determining comprises identifying repeated purchases of a same type of product based on the purchase history information. A category for the same type of product is determined. A second recommendation for the first user is generated based on the determined second pattern of purchasing activity, with the second recommendation comprising a product recommendation for a product of the category on the first website. The second recommendation is caused to be presented to the first user on the first computing device.

In some example embodiments, a second pattern of purchasing activity for the first user is determined based on the purchase history information, with the second pattern comprising a lack of use of a specified payment mechanism. A second recommendation for the first user is generated based on the determined second pattern of purchasing activity, with the second recommendation comprising a payment recommendation for the specified payment mechanism. The second recommendation is caused to be presented to the first user on the first computing device. In some example embodiments, the payment recommendation is configured to enable the first user to create an electronic payment account for the specified payment mechanism.

In some example embodiments, a second recommendation is generated based on the purchase history information, with the second recommendation comprising a compliment product recommendation corresponding to at least one product that is configured to be used in conjunction with at least one previously-purchased product identified in the purchase history information.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

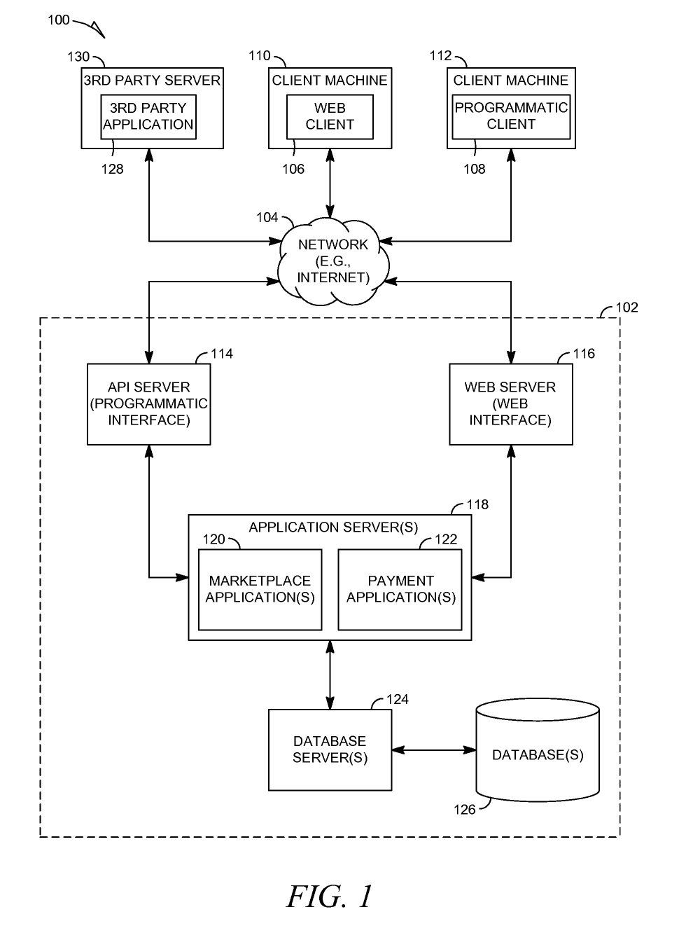

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

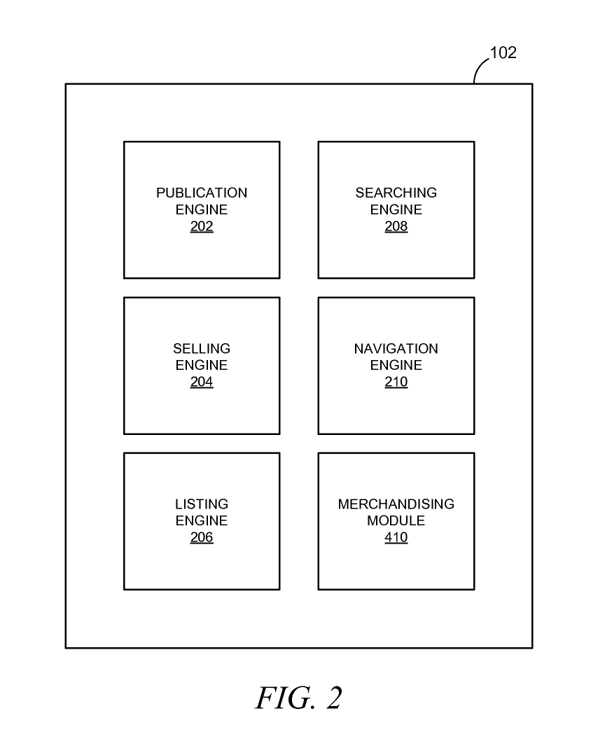

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 may also allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 208 may record the query (e.g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify as part of the search query a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listings is reached. Various other navigation applications within the navigation engine 210 may be provided to supplement the searching and browsing applications. The navigation engine 210 may record the various user actions (e.g., clicks) performed by the user in order to navigate down the category tree.

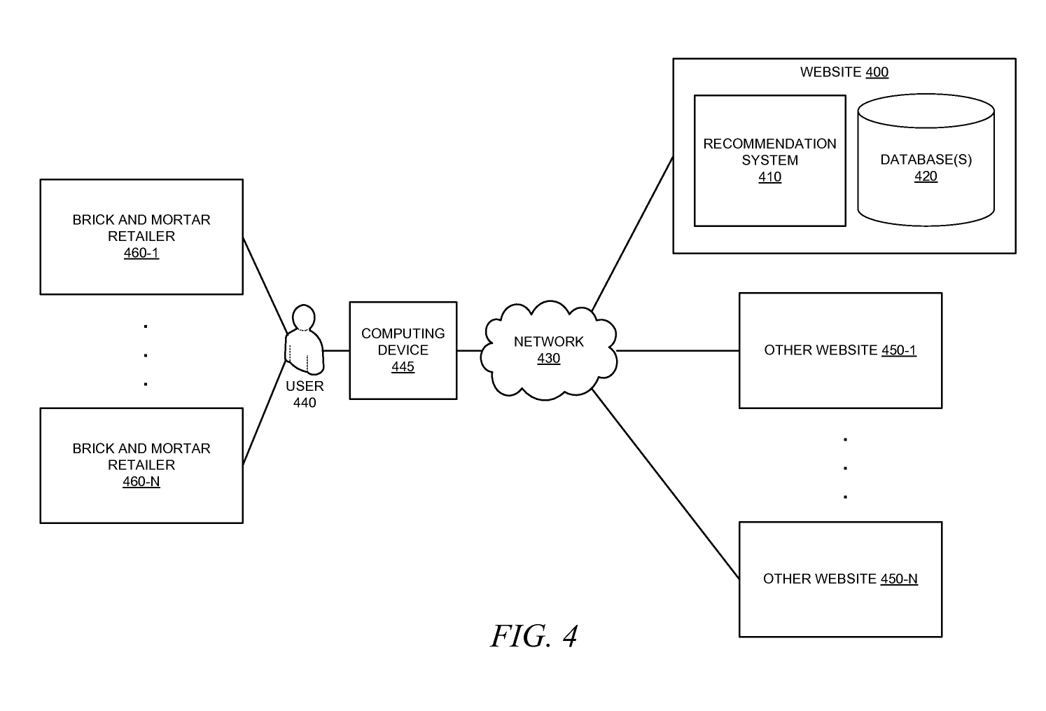

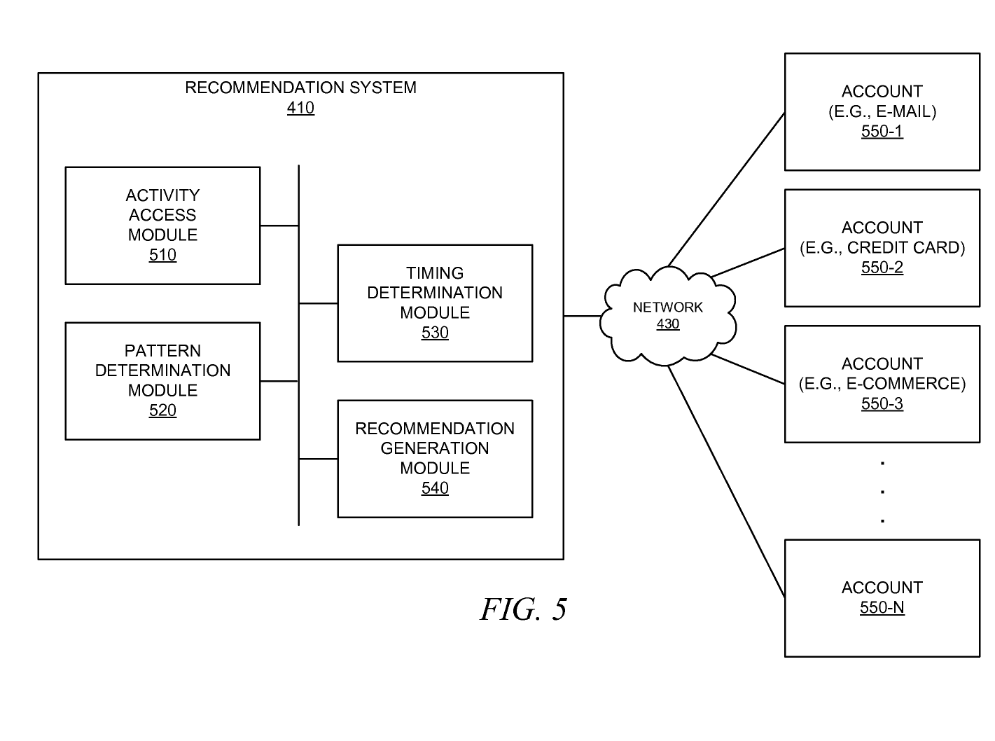

In some embodiments, a recommendation system 410 may be configured to provide functionality for providing merchandising for a website based on off-site purchase history of a user. The features, functions, and operations of the recommendation system 410 will be discussed in further detail below with respect to FIGS. 4-5.

Additional modules and engines associated with the networked system 102 are described below in further detail. It should be appreciated that modules or engines may embody various aspects of the details described below.

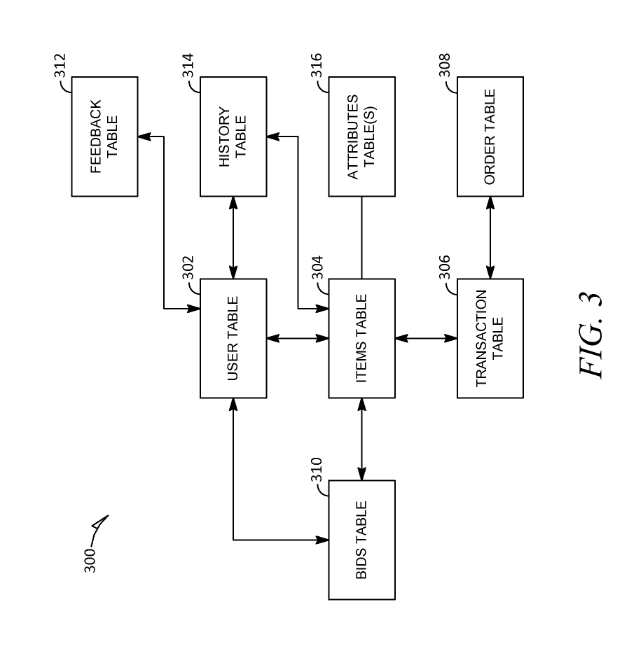

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, with the currency attribute identifying the currency of a price for the relevant item as specified by a seller.

FIG. 4 is a block diagram illustrating components of a system for providing merchandising for a website 400 based on off-site purchase history of a user 440. In some embodiments, the website 400 is an e-commerce site. In some embodiments, the website 400 may host the selling of items from one or more sellers (e.g., eBay® or Amazon®). The user 440 may use a computing device 445 to access the website 440 and perform shopping actions, including, but not limited to, searching, browsing, bidding, and/or purchasing of items. Examples of a user computing device 445 include, but are not limited to, a smart phone, a tablet computer, a wearable computing device, a vehicle computing device, a laptop computer, and a desktop computer. Other types of computing devices 445 are also within the scope of the present disclosure.

The website 400 may be implemented as part of the networked system 102 in FIG. 1 and may incorporate the features discussed above with respect to FIGS. 1-3. The user 440 can also access one or more other websites 450-1 to 450-N, and perform shopping actions, including, but not limited to, searching, browsing, bidding, and/or purchasing of items. In some embodiments, the other websites 450-1 to 450-N are separate and independent from the website 400. For example, website 400 may be eBay.com®, while other website 450-1 may be Amazon.com®.

Any of the communication described herein between any of the systems, devices, modules, or websites (e.g., any communication between the computing device 445 and the website 400 and/or the other websites 450-1 to 450-N) can be achieved via one or more networks 430. The network(s) 430 may include any network that enables communication between or among machines, databases, and devices. Accordingly, the network(s) may include a wired network, a wireless network (e.g., a mobile or cellular network), or any suitable combination thereof. The network(s) may include one or more portions that constitute a private network, a public network (e.g., the Internet), or any suitable combination thereof. Other configurations are also within the scope of the present disclosure.

A recommendation system 410 can be employed by the website 400 to generate recommendations for the user 440 based on information about the user's off-site purchase history. In some embodiments, the term “off-site” is used herein to refer to activity on a website (e.g., other websites 450-1 to 450-N) other than the website 400 for which the recommendation system 410 is being employed, as well as activity at a brick and mortar retailer, such as brick and mortar retailers 460-1 to 460-N. For example, the recommendation system 410 can use information about the user's online purchasing activity on Amazon.com® and offline purchasing activity at a physical Target® store to generate and provide recommendations to the user regarding potential future activity on eBay.com®.

It is contemplated that the recommendation system 410 can obtain the purchase history of the user 440 in a variety of ways. In some embodiments, the recommendation system 410 obtains the purchase history of the user 440 by accessing one or more e-mail accounts of the user 440, scanning the e-mail in the e-mail accounts for information indicating purchases by the user 440 (e.g., from receipts and/or credit card statements), and extracting this information from the e-mail. In some embodiments, the recommendation system 410 can obtain the purchase history of the user 440 from one or more accounts associated with the other websites (450-1 to 450-N) or brick and mortar retailers (460-1 to 460-N). For example, the user 440 can authorize the recommendation system 410 to be granted access to his or her Amazon® account and Target® account to retrieve the purchase history information. In some embodiments, the user 440 can authorize the recommendation system 410 to be granted access to his or her credit card account to retrieve the purchase history informations. The user 440 can link any number of sources of purchase history information (e.g., e-mail accounts, e-commerce accounts, brick and mortar retailer accounts, and credit card accounts) to the recommendation system 410 to enable the recommendation system 410 to obtain the purchase history information.

In some embodiments, the purchase history information of the user 440 can be stored in one or more databases 420. In some embodiments, database(s) 420 may be incorporated into database(s) 126 in FIG. 1. However, it is contemplated that other configurations are also within the scope of the present disclosure.

The recommendation system 410 can analyze the received information about the off-site purchase history of the user 440 in order to understand the user's personal shopping habits. The recommendation system 410 can also use information about the on-site purchase history of the user 440 (e.g., purchasing activity on the website 400) to facilitate this understanding of the user's personal shopping habits. From this information, the recommendation system 410 can learn what items the user has purchased, where the items were purchased from, how much the items were purchased for, and how often and with what frequency or regularity the items were purchased. The recommendation system 410 can also use the received information to understand the gap between a user's purchasing habits on the website 400 and the user's purchasing habits off of the website. The recommendation system 410 can then use what it has learned about the user's shopping activity or habits to generate recommendations for the user.

The recommendation system 410 can generate recommendations of on-site substitutes for a user's previous off-site purchases. In some embodiments, the recommendation system 410 can use its understanding of the gap between what the user 440 has purchased on-site (e.g., on website 400) versus what the user 440 has purchased off-site (e.g., on other websites 450-1 to 450-N and/or in brick and mortar stores 460-1 to 460-N) to generate a recommendations indicating that an item the user 440 bought off-site could have been, and still can be, bought on-site for a better price. For example, the recommendation system 410 can use its knowledge of the user 440 regularly buying a monthly supply of toilet paper on Amazon.com® to recommend a better deal on a monthly supply of toilet paper on eBay.com®.

The recommendation system 410 can also generate recommendations of on-site compliments for a user's previous off-site purchases. For example, the recommendation system 410 can determine the user's coffee drinking habits based on received information that the user goes to Starbucks® often. Based on this determination, the recommendation system 410 can recommend coffee beans that the user 440 should buy on the website 400. In some example embodiments, a compliment item comprises a product that is configured to be used in conjunction with one or more products previously purchased by the user 440. The compliment product can be configured to be used in structural conjunction with the previously-purchased product (e.g., both products being physically connected to one another) and/or in functional conjunction with the previously-purchased product (e.g., at least one of the products is configured to perform a function that affects the operation of the other product). For example, the recommendation system 410 can use its knowledge of the user 440 having purchased a particular flat screen television set on Amazon.com® to recommend a corresponding wall mount or a stand for the television set on eBay.com®.

The recommendation system 410 can determine what product the user 440 bought and what category the product belong to. The recommendation system 410 can then determine what other products are in that category and recommend those products to the user 440. In some embodiments, the recommendation system 410 can analyze the information of the purchase history, such as product titles listed in receipts, and determine what is the closest category that each product belongs to based on the terms in the title. Once the recommendation system 410 knows what category each product belongs to, it can figure out the user's purchasing habits.

In some embodiments, the recommendation system 410 can use the information about the user's purchasing habits to determine scheduling for recommendations, thereby maximizing the effectiveness of the timing of advertising and promotional campaigns. The recommendation system 410 can analyze the frequency of the user's purchasing activity and schedule an advertising campaign directed at that user for a time that has been determined to correspond to when the user will be prone to shopping, which can be determined based on the analysis of the user's shopping frequency. In one example, the recommendation system 410 may determine that the user 440 purchases a certain quantity of toilet paper once a month. The recommendation system 410 can then use this determination to provide a recommendation to the user 440 (e.g., via e-mail or on the website 400) to buy toilet paper on the website 400 at or near (e.g., shortly before or shortly after) a time when the one month period is going to end. For example, if the user 440 typically purchases the toilet paper at the beginning of the month, then the recommendation system 410 can provide the recommendation to the user 440 at the beginning of the month or at the very end of the preceding month (e.g., a predetermined amount of time before an estimated time at which the user typically purchases the item). The recommendation may include a discount coupon or some other promotional item or incentive to attract the user 440).

As noted above, the recommendation system 410 can learn a lot about the user's purchasing habits, including, but not limited to, the frequency of purchasing from a certain store, certain category of stores, certain products, and certain categories of products. This information can then be used to generate recommendations, including advertisements and other promotional content, for the user 440.

In some embodiments, the recommendation system 410 can generate a recommendation for the user 440 to join the website 400 (e.g., create an account on the website 400) based on a determination that the user 440 is not a member of the website 400. The recommendation can include incentives to join the website 400 based upon a shopping profile of the user 440, which can be determined based on the information about the user's purchase history. For example, such a recommendation can include an indication (e.g., a statement) that the user 440 is spending a certain amount of money at certain off-site locations (e.g., other websites 450-1 to 450-N and/or brick and mortar retailers 460-1 to 460-N) and could get a discount at the website 400.

In some embodiments, the recommendation system 410 can generate a recommendation for the user 440 to use a certain payment mechanism based on a determination that the user 440 has not used that payment mechanism in the past. For example, the recommendation system 410 can determine that the user 440 does not use PayPal® based on an analysis of the information about the user's purchase history. Based on this determination, the recommendation system 410 can generate a recommendation for the user 440 to create and use a PayPal® account. The recommendation can include a link to PayPal's website.

FIG. 5 is a block diagram illustrating components of the recommendation system 410, in accordance with some embodiments. In some example embodiments, the recommendation system 410 comprises any combination of one or more of an activity module 510, a pattern determination module 520, a timing determination module 530, and a recommendation generation module 540. The modules 510, 520, 530, and 540 can reside on a machine having a memory and at least one processor (not shown). In some example embodiments, the modules 510, 520, 530, and 540 can be incorporated into the application server(s) 118 in FIG. 1. However, it is contemplated that other configurations are also within the scope of the present disclosure.

In some example embodiments, the activity access module 510 is configured to receive user input identifying at least one account 550 (e.g, 550-1 to 550-N in FIG. 5) of a user 440, with each one of the account(s) 550 being hosted by a corresponding online service independent of the website 400. The account(s) 550 can comprise any combination of one or more of an e-mail account 550-1 of the user 440, a credit card account 550-2 of the user 440, and an e-commerce account 550-3 with an e-commerce website independent of the website 400. The activity access module 510 can also be configured to establish a link with the account(s) 550 of the user 440 based on a user-generated interrupt corresponding to the user input. The user input can comprise the user 440 entering identification(s) of the account(s) 550 using a user interface on the computing device 445. The activity access module 510 can be further configured to access purchase history information of the user 440 from the account(s) 550 of the user 440.

In some example embodiments, the pattern determination module 520 is configured to determine one or more patterns of purchasing activity for the user 440 based on the purchase history information. For example, it can be determined that the user 440 has purchased a certain amount of toilet paper four times in the last four months from entities other than the website 400, with one toilet paper purchase during the first week of every month, which can be determined by the pattern determination module 520 to be a pattern.

However, the pattern determination module 520 can require that a predetermined threshold level of repeated purchases be satisfied in order to determine that a pattern has been established. In some example embodiments, the pattern determination module 520 is further configured to identify repeated purchases of a same type of product based on the purchase history information. The term “type” as used within the present disclosure is distinguished form “category”. Products of the same type have the same function, such as different brands of toilet paper, whereas products of the same category may have different functions, such as a printer and an ink cartridge for the printer. The pattern determination module 520 can be further configured to calculate a frequency of the repeated purchases, determine that the frequency of the repeated purchases satisfies a predetermined threshold value, and determine that a pattern of purchasing activity comprises the repeated purchase of the identified same type of product.

In some example embodiments, the timing determination module 530 is configured to determine a presentation time for a recommendation based on a determined pattern of purchasing activity.

In some example embodiments, the recommendation generation module 540 is configured to generate a recommendation for the user 440 based on a determined pattern of purchasing activity, and to cause the recommendation to be presented to the user 440 on the computing device 445 at the determined presentation time. The recommendation can comprise a content of the website 400.

In some example embodiments, the pattern determination module 520 is further configured to identify repeated purchases of a same type of product based on the purchase history information, and the recommendation generation module 540 is further configured to determine a category for the same type of product, and to generate a recommendation for the user 440 based on a determined pattern of purchasing activity. The pattern can be determined based on the identified repeated purchases. The recommendation can comprise a product recommendation for a product of the category on the website 400. The recommendation generation module 540 can be further configured to cause the recommendation to be presented to the user 440 on the computing device 445.

In some example embodiments, the pattern determination module 520 is further configured to determine a pattern of purchasing activity for the user 440 based on the purchase history information, where the pattern comprises a lack of use of a specified payment mechanism, such as the user 440 not using a specified electronic payment account. The recommendation generation module 540 can be further configured to generate a recommendation for the user 440 based on this determined pattern of purchasing activity, where the recommendation comprises a payment recommendation for the specified payment mechanism, and to cause this recommendation to be presented to the user 440 on the computing device 445. The payment recommendation can be configured to enable the user 440 to create an electronic payment account for the specified payment mechanism. For example the payment recommendation can comprise a link to a page for creating an electronic payment account.

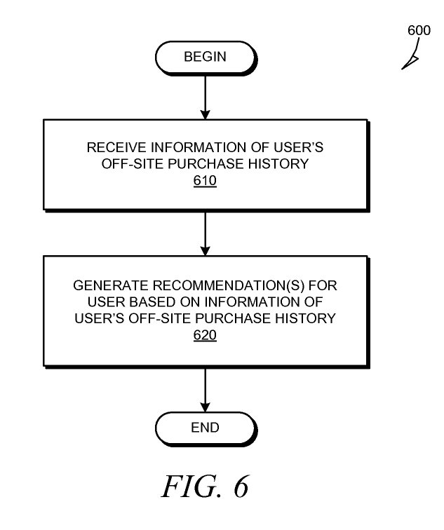

FIG. 6 is a flowchart illustrating a method 600 of providing recommendations, in accordance with some embodiments. Method 600 can be performed by processing logic that can comprise hardware (e.g., circuitry, dedicated logic, programmable logic, microcode, etc.), software (e.g., instructions run on a processing device), or a combination thereof. In one example embodiment, the method 600 is performed by the recommendation system 410 of FIGS. 3 and 4, or any combination of one or more of its components or modules, as described above. At operation 610, information about the purchase history of the user 440 can be received. This information can be obtained using any of the techniques disclosed herein, as well as other techniques. At operation 620, one or more recommendations for the user 440 can be generated based on the information about the purchase history of the user 440. These recommendations may comprise any of the features disclosed herein, as well as other features. Additionally, these recommendations may be generated using any of the techniques disclosed herein, as well as other techniques. It is contemplated that the operations of method 600 may incorporate any of the other features disclosed herein.

In some embodiments, purchase information from a first purchasing platform (e.g., offline or brick-and-mortar purchases) can be used to generate recommendations for and/or on a second purchasing platform (e.g., an online medium, such as the Internet). Although examples are provided with a first purchasing platform being offline/brick-and-mortar and a second purchasing platform being online, it is contemplated that, in some embodiments, the first purchasing platform can be one website and the second purchasing platform can be another separate and independent website.

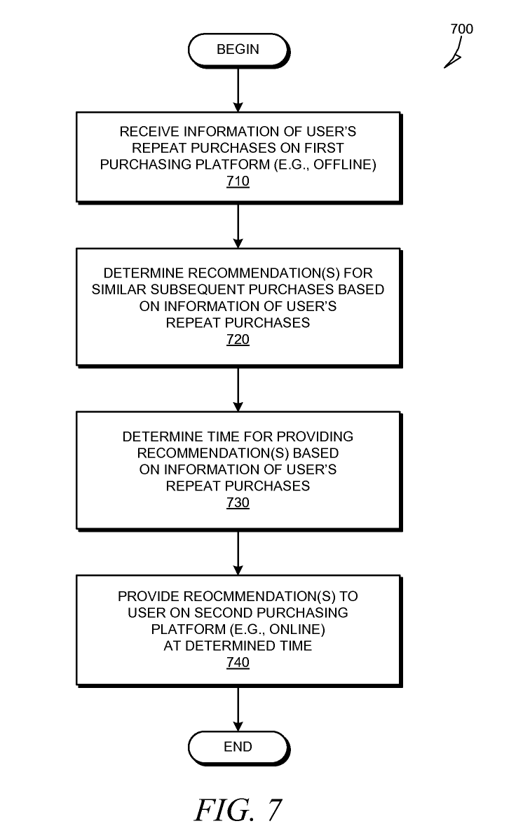

In some embodiment, information about a user's repeat purchase of products on a first platform (e.g., offline) can be used to recommend products at the right time on a second platform (e.g., online) for similar subsequent purchases. FIG. 7 is a flowchart illustrating a method 700 of providing recommendations, in accordance with some embodiments. Method 700 can be performed by processing logic that can comprise hardware (e.g., circuitry, dedicated logic, programmable logic, microcode, etc.), software (e.g., instructions run on a processing device), or a combination thereof. In one example embodiment, the method 700 is performed by the recommendation system 410 of FIGS. 3 and 4, or any combination of one or more of its components or modules, as described above. At operation 710, information of a user's repeat purchases on a first purchasing platform (e.g., offline) are received. At operation 720, one or more recommendations for similar subsequent purchases are determined based on the information of the user's repeat purchases. At operation 730, an appropriate time is determined for providing one or more recommendations of the same or similar products to the user based on information of the user's repeat purchases. At operation 740, the one or more recommendations are provided to the user on a second purchasing platform (e.g., online) at the determined appropriate time. It is contemplated that the operations of method 700 may incorporate any of the other features disclosed herein.

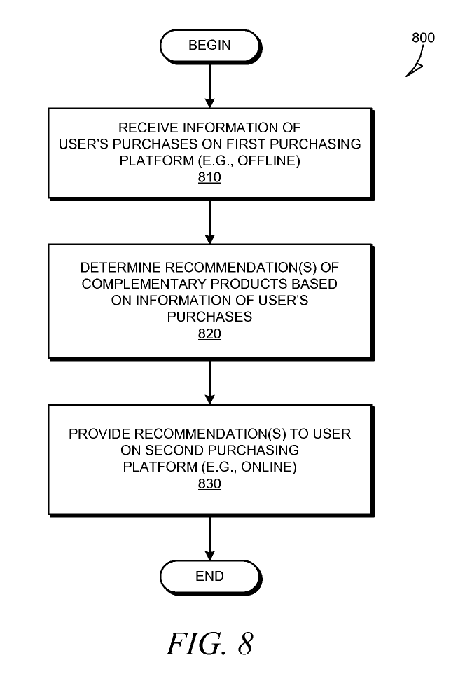

In some embodiments, product purchase information from a first platform (e.g., offline) can be used to recommend one or more complementary products on a second platform (e.g., online). FIG. 8 is a flowchart illustrating a method 800 of providing recommendations, in accordance with some embodiments. Method 800 can be performed by processing logic that can comprise hardware (e.g., circuitry, dedicated logic, programmable logic, microcode, etc.), software (e.g., instructions run on a processing device), or a combination thereof. In one example embodiment, the method 800 is performed by the recommendation system 410 of FIGS. 3 and 4, or any combination of one or more of its components or modules, as described above. At operation 810, information of a user's purchases on a first purchasing platform (e.g., offline) are received. At operation 820, one or more recommendations of complementary products are determined based on the information of the user's purchases. At operation 830, the one or more recommendations are provided to the user on a second purchasing platform (e.g., online). It is contemplated that the operations of method 800 may incorporate any of the other features disclosed herein.

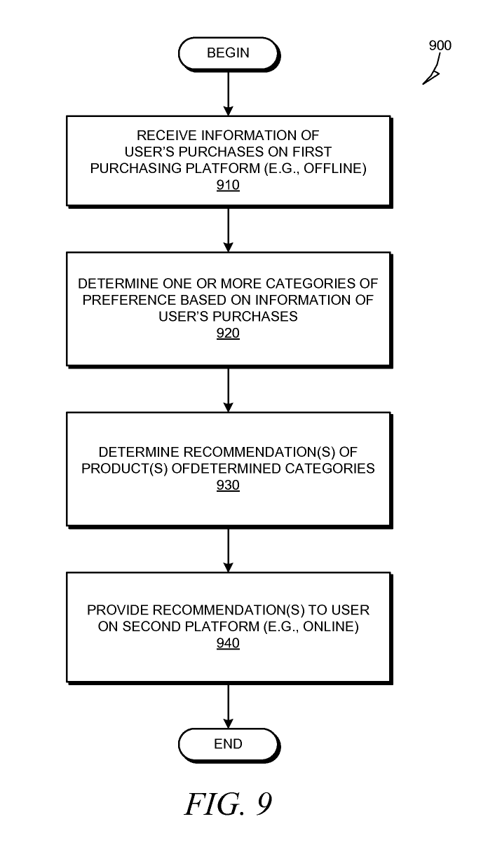

In some embodiments, aggregate information of purchases on a first platform (e.g., offline) can be used to extract category or categories of preference and recommend products from that category on a second platform (e.g., online). The recommended category can be the category where the user has affinity of purchase (to exploit user preference) or can be a category where the user has no affinity at all (to explore new categories). FIG. 9 is a flowchart illustrating a method 800 of providing recommendations, in accordance with some embodiments. Method 900 can be performed by processing logic that can comprise hardware (e.g., circuitry, dedicated logic, programmable logic, microcode, etc.), software (e.g., instructions run on a processing device), or a combination thereof. In one example embodiment, the method 900 is performed by the recommendation system 410 of FIGS. 3 and 4, or any combination of one or more of its components or modules, as described above. At operation 910, information of a user's purchases on a first purchasing platform (e.g., offline) are received. At operation 920, one or more categories of preference are determined based on the information of the user's purchases. At operation 930, one or more recommendations of products of the one or more categories are determined. At operation 940, the one or more recommendations are provided to the user on a second purchasing platform (e.g., online). It is contemplated that the operations of method 900 may incorporate any of the other features disclosed herein.

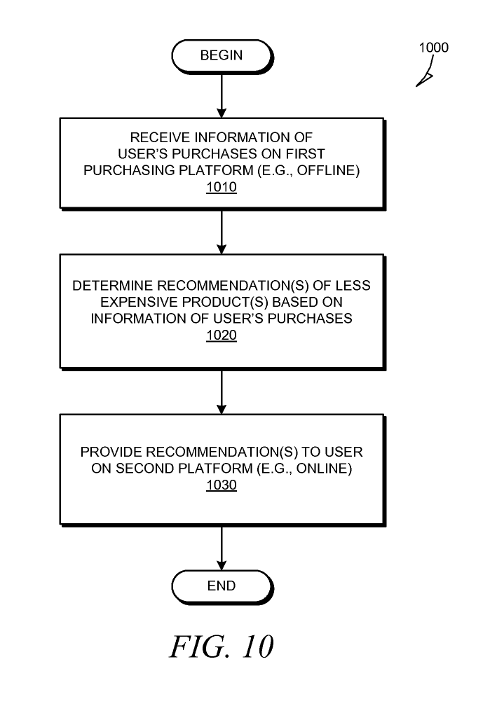

In some embodiments, price information of one or more user purchases from a first platform (e.g., offline) can be used to recommend cheaper products to the user on a second platform (e.g., online). FIG. 10 is a flowchart illustrating a method 1000 of providing recommendations, in accordance with some embodiments. Method 1000 can be performed by processing logic that can comprise hardware (e.g., circuitry, dedicated logic, programmable logic, microcode, etc.), software (e.g., instructions run on a processing device), or a combination thereof. In one example embodiment, the method 1000 is performed by the recommendation system 410 of FIGS. 3 and 4, or any combination of one or more of its components or modules, as described above. At operation 1010, information of a user's purchases on a first purchasing platform (e.g., offline) is received. At operation 1020, one or more recommendations of one or more less expensive products are determined based on the information of the user's purchases. At operation 1030, the one or more recommendations are provided to the user on a second platform (e.g., online). It is contemplated that the operations of method 1000 may incorporate any of the other features disclosed herein.

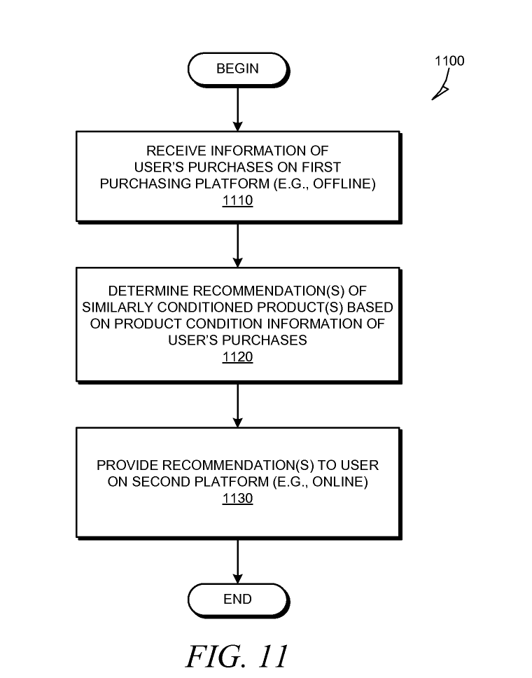

In some embodiments, product condition information (e.g., “used” or “new”) from user purchases on a first platform (e.g., offline) can be used to recommend products of similar condition to the user on a second platform (e.g., online). FIG. 11 is a flowchart illustrating a method 1100 of providing recommendations, in accordance with some embodiments. Method 1100 can be performed by processing logic that can comprise hardware (e.g., circuitry, dedicated logic, programmable logic, microcode, etc.), software (e.g., instructions run on a processing device), or a combination thereof. In one example embodiment, the method 1100 is performed by the recommendation system 410 of FIGS. 3 and 4, or any combination of one or more of its components or modules, as described above. At operation 1110, information of a user's purchases on a first purchasing platform (e.g., offline) is received. At operation 1120, one or more recommendations of similarly conditioned products are determined based on product condition information of the user's purchases. At operation 1130, the one or more recommendations are provided to the user on a second purchasing platform (e.g., online). It is contemplated that the operations of method 1100 may incorporate any of the other features disclosed herein.

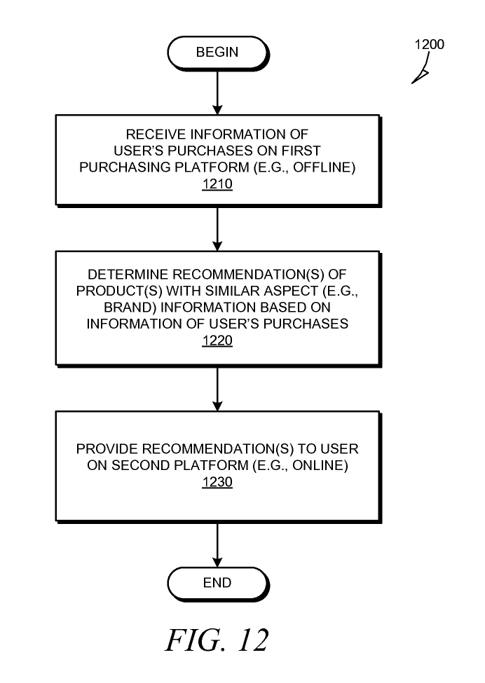

In some embodiments, brand information, or other aspect information, from products purchased by a user on a first platform (e.g., offline) can be used to recognize brand affinity to recommend products to the user on a second platform (e.g., online). FIG. 12 is a flowchart illustrating a method 1200 of providing recommendations, in accordance with some embodiments. Method 1200 can be performed by processing logic that can comprise hardware (e.g., circuitry, dedicated logic, programmable logic, microcode, etc.), software (e.g., instructions run on a processing device), or a combination thereof. In one example embodiment, the method 1200 is performed by the recommendation system 410 of FIGS. 3 and 4, or any combination of one or more of its components or modules, as described above. At operation 1210, information of a user's purchases on a first purchasing platform (e.g., offline) is received. At operation 1220, one or more recommendations of one or more products with similar aspect information (e.g., similar brand) as the previous purchases are determined based on the information of the user's purchases. At operation 1230, the one or more recommendations are provided to the user on a second purchasing platform (e.g., online). It is contemplated that the operations of method 1200 may incorporate any of the other features disclosed herein.

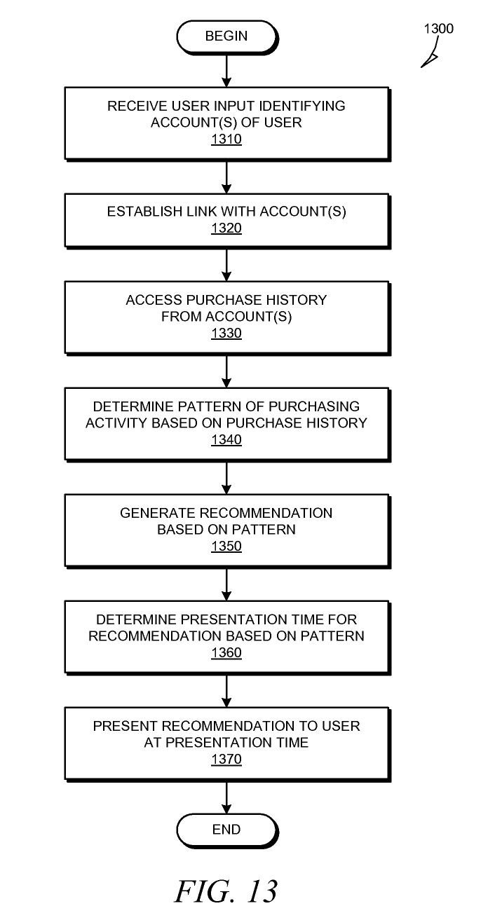

FIG. 13 is a flowchart illustrating a method 1300 of providing recommendations, in accordance with some embodiments. Method 1300 can be performed by processing logic that can comprise hardware (e.g., circuitry, dedicated logic, programmable logic, microcode, etc.), software (e.g., instructions run on a processing device), or a combination thereof. In one example embodiment, the method 1300 is performed by the recommendation system 410 of FIGS. 3 and 4, or any combination of one or more of its components or modules, as described above.

At operation 1310, user input identifying at least one account 550 of a user 440 is received, with each one of the account(s) 550 being hosted by a corresponding online service independent of a website 400. In some example embodiments, the account(s) 550 comprises at least one of an e-mail account of the user, a credit card account of the user, and an e-commerce account with an e-commerce website. At operation 1320, a link with the account(s) 550 of the user is established based on a user-generated interrupt corresponding to the user input. At operation 1330, purchase history information of the user 440 is accessed from the account(s) 550 of the user 440. At operation 1340, a pattern of purchasing activity for the user 440 is determined based on the purchase history information. For example, it can be determined that the user 440 has purchased a certain amount of toilet paper four times in the last four months from entities other than the website 400, with one toilet paper purchase during the first week of every month. At operation 1350, a recommendation for the user 440 is generated based on the determined pattern of purchasing activity. The recommendation comprises a content of the website 400. In the example above, the recommendation can comprise an advertisement of toilet paper being offered for sale on the website 400 In some example, embodiments, the content comprises one or more items offered for sale on the website 400. At operation 1360, a presentation time for the recommendation is determined based on the determined pattern of purchasing activity. In the above example, based on the pattern of the user making one toilet paper purchase during the first week of every month during the last four months, the last week of every month can be determined to be the presentation time for the recommendation, in order to present the user 440 with the recommendation during or just before a time the user 440 will be making another purchase. At operation 1370, the recommendation is caused to be presented to the user 440 on a computing device 445 at the determined presentation time. The recommendation can be presented in a variety of ways, including, but not limited to, as a recommendation on a page of the website 400, as a recommendation in an e-mail message sent to the user 440, and as a recommendation in a text message sent to the user. It is contemplated that the operations of method 1300 may incorporate any of the other features disclosed herein.

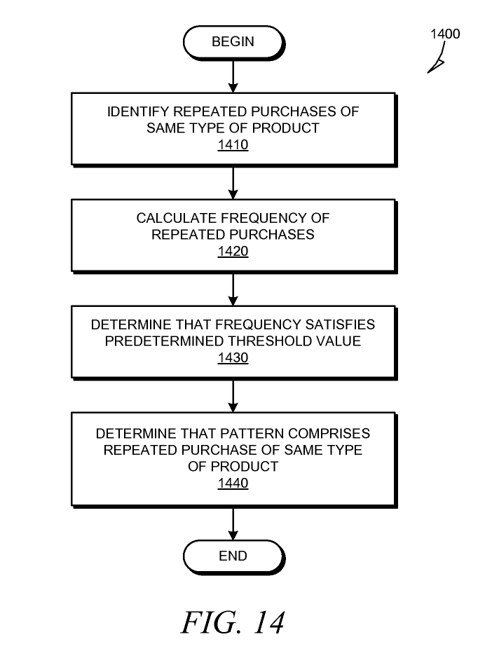

FIG. 14 is a flowchart illustrating a method 1400 of determining a pattern of purchasing activity, in accordance with some embodiments. Method 1400 can be performed by processing logic that can comprise hardware (e.g., circuitry, dedicated logic, programmable logic, microcode, etc.), software (e.g., instructions run on a processing device), or a combination thereof. In one example embodiment, the method 1400 is performed by the recommendation system 410 of FIGS. 3 and 4, or any combination of one or more of its components or modules, as described above.

At operation 1410, repeated purchases of a same type of product are identified based on the purchase history information. At operation 1420, a frequency of the repeated purchases is calculated. At operation 1430, it is determined that the frequency of the repeated purchases satisfies a predetermined threshold value. For example, a predetermined threshold value can be at least on toilet paper purchase every month for the last four months. At operation 1440, it is determined that the repeated purchase of the same type of product is a pattern of purchasing activity. In some example embodiments, the first recommendation comprises a product recommendation of the same type of product on the first website, and the presentation time for the first recommendation is based on the frequency of the repeated purchases. It is contemplated that the operations of method 1400 may incorporate any of the other features disclosed herein.

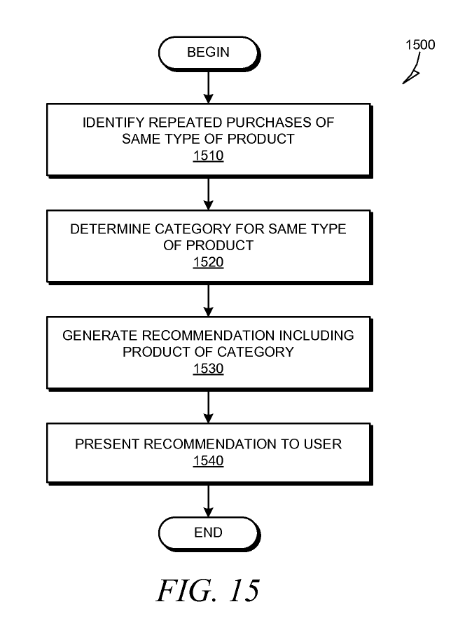

FIG. 15 is a flowchart illustrating a method 1500 of providing recommendations, in accordance with some embodiments. Method 1500 can be performed by processing logic that can comprise hardware (e.g., circuitry, dedicated logic, programmable logic, microcode, etc.), software (e.g., instructions run on a processing device), or a combination thereof. In one example embodiment, the method 1500 is performed by the recommendation system 410 of FIGS. 3 and 4, or any combination of one or more of its components or modules, as described above.

At operation 1510, a pattern of purchasing activity for a user 440 is determined based on the purchase history information, which can comprise identifying repeated purchases of a same type of product based on the purchase history information. At operation 1520, a category for the same type of product is determined. For example, it can be determined that the user has made several purchases of coffee within the last four months, and thus coffee can be determined to be a category. At operation 1530, a recommendation for the user 440 is generated based on the previously discussed determined pattern of purchasing activity, with the recommendation comprising a product recommendation for a product of the category on the website 400. In the example above of coffee being determined to be the category, the product recommendation can comprise a recommendation of coffee beans being offered for sale on the website 400. At operation 1540, the recommendation is caused to be presented to the user 440 on the computing device 445. The recommendation can be presented in a variety of ways, including, but not limited to, as a recommendation on a page of the website 400, as a recommendation in an e-mail message sent to the user 440, and as a recommendation in a text message sent to the user. It is contemplated that the operations of method 1500 may incorporate any of the other features disclosed herein.

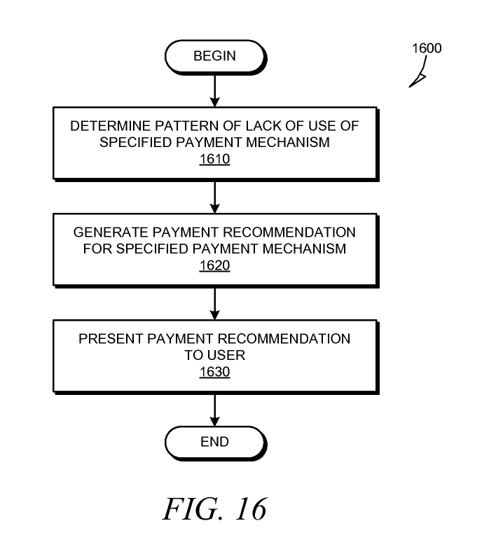

FIG. 16 is a flowchart illustrating a method 1600 of providing recommendations, in accordance with some embodiments. Method 1600 can be performed by processing logic that can comprise hardware (e.g., circuitry, dedicated logic, programmable logic, microcode, etc.), software (e.g., instructions run on a processing device), or a combination thereof. In one example embodiment, the method 1600 is performed by the recommendation system 410 of FIGS. 3 and 4, or any combination of one or more of its components or modules, as described above.

At operation 1610, a pattern of purchasing activity for a user 440 is determined based on the purchase history information, with the pattern comprising a lack of use of a specified payment mechanism. At operation 1620, a recommendation for the user 440 is generated based on the determined pattern of purchasing activity, with the recommendation comprising a payment recommendation for the specified payment mechanism. At operation 1630, the recommendation is caused to be presented to the user 440 on the computing device 445. In some example embodiments, the payment recommendation is configured to enable the user 440 to create an electronic payment account for the specified payment mechanism. In one example, it can be determined that the user 440 has never used a PayPal® account to pay for any purchases. Based on this determination, a payment recommendation can be presented to the user 440. The payment recommendation can comprise a link to a page for creating a PayPal® account. The recommendation can be presented in a variety of ways, including, but not limited to, as a recommendation on a page of the website 400, as a recommendation in an e-mail message sent to the user 440, and as a recommendation in a text message sent to the user. It is contemplated that the operations of method 1600 may incorporate any of the other features disclosed herein.

It is contemplated that any features of any embodiments disclosed herein can be combined with any other features of any other embodiments disclosed herein. Accordingly, these any such hybrid embodiments are within the scope of the present disclosure.

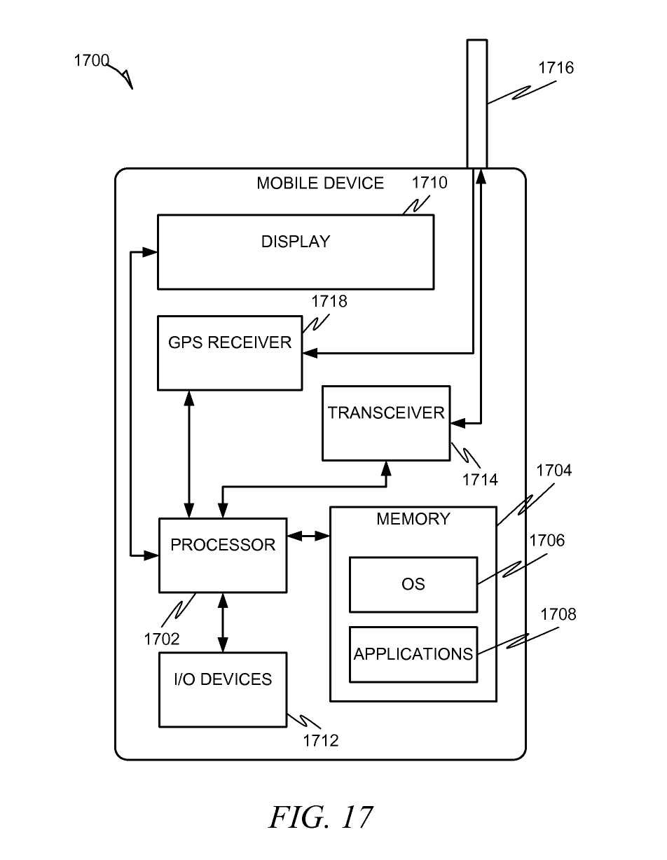

FIG. 17 is a block diagram illustrating a mobile device 1700, according to some example embodiments. The mobile device 1700 can include a processor 1702. The processor 1702 can be any of a variety of different types of commercially available processors suitable for mobile devices 1700 (for example, an XScale architecture microprocessor, a Microprocessor without Interlocked Pipeline Stages (MIPS) architecture processor, or another type of processor). A memory 1704, such as a random access memory (RAM), a Flash memory, or other type of memory, is typically accessible to the processor 1702. The memory 1704 can be adapted to store an operating system (OS) 1706, as well as application programs 1708, such as a mobile location enabled application that can provide LBSs to a user. The processor 1702 can be coupled, either directly or via appropriate intermediary hardware, to a display 1710 and to one or more input/output (I/O) devices 1712, such as a keypad, a touch panel sensor, a microphone, and the like. Similarly, in some example embodiments, the processor 1702 can be coupled to a transceiver 1714 that interfaces with an antenna 1716. The transceiver 1714 can be configured to both transmit and receive cellular network signals, wireless data signals, or other types of signals via the antenna 1716, depending on the nature of the mobile device 1700. Further, in some configurations, a GPS receiver 1718 can also make use of the antenna 1716 to receive GPS signals.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

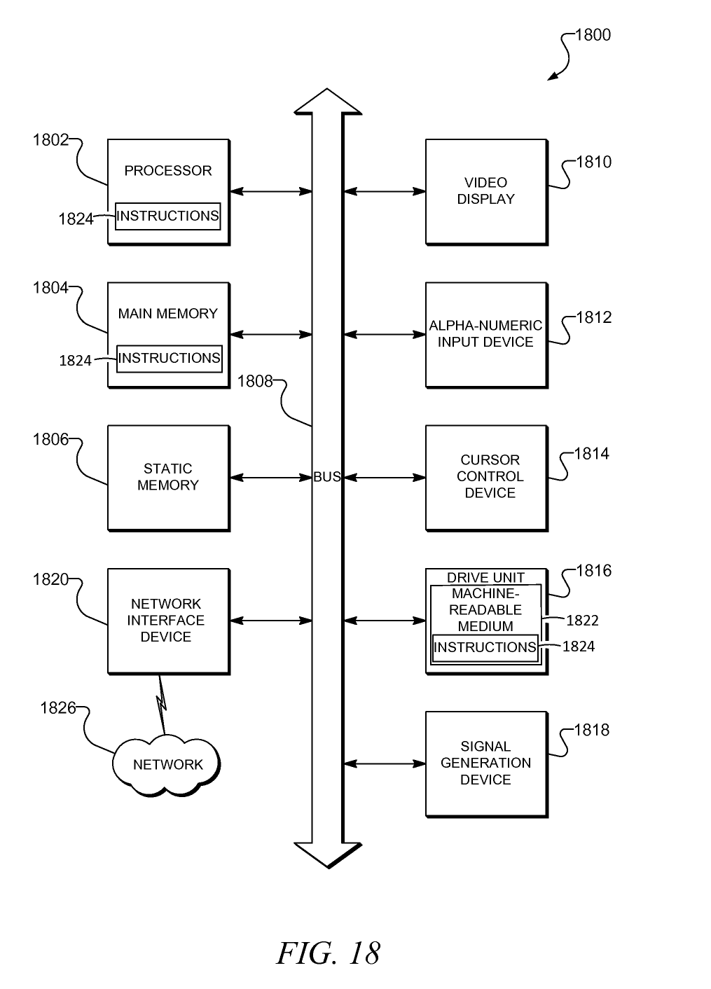

FIG. 18 is a block diagram of a machine in the example form of a computer system 1800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a user interface (UI) navigation (or cursor control) device 1814 (e.g., a mouse), a disk drive unit 1816, a signal generation device 1818 (e.g., a speaker), and a network interface device 1820.

The disk drive unit 1816 includes a machine-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable medium 1822 is shown in an example embodiment to be a single medium, the term “machine-readable medium” may include a single medium or multiple media (e.g., a centralized or distributed database, and/or associated caches and servers) that store the one or more instructions 1824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a machine having a memory and at least one processor;
an activity access module, executable by the at least one processor, configured to:
receive user input identifying at least one account of a first user, each one of the at least one account being hosted by a corresponding online service independent of a first website;
establish a link with the at least one account of the first user based on a user-generated interrupt corresponding to the user input; and
access purchase history information of the first user from the at least one account of the first user;
a pattern determination module configured to determine a first pattern of purchasing activity for the first user based on the purchase history information;
a timing determination module configured to determine a presentation time for a first recommendation based on the determined first pattern of purchasing activity; and
a recommendation generation module configured to:
generate a first recommendation for the first user based on the determined first pattern of purchasing activity, the first recommendation comprising a first content of the first website; and
cause the first recommendation to be presented to the first user on a first computing device at the determined presentation time.

2. The system of claim 1, wherein the at least one account comprises at least one of an e-mail account of the first user, a credit card account of the first user, and an e-commerce account with an e-commerce website.

3. The system of claim 1, wherein the pattern determination module is further configured to:
identify repeated purchases of a same type of product based on the purchase history information;
calculate a frequency of the repeated purchases;
determine that the frequency of the repeated purchases satisfies a predetermined threshold value; and
determine that the first pattern of purchasing activity comprises the repeated purchase of the same type of product.

4. The system of claim 3, wherein the first recommendation comprises a product recommendation of the same type of product on the first website, and the presentation time for the first recommendation is based on the frequency of the repeated purchases.

5. The system of claim 1, wherein:
the pattern determination module is further configured to determine a second pattern of purchasing activity for the first user based on the purchase history information, the determining of the second pattern comprising identifying repeated purchases of a same type of product based on the purchase history information; and
the recommendation generation module is further configured to:
determine a category for the same type of product;
generate a second recommendation for the first user based on the determined second pattern of purchasing activity, the second recommendation comprising a product recommendation for a product of the category on the first website; and
cause the second recommendation to be presented to the first user on the first computing device.

6. The system of claim 1, wherein:
the pattern determination module is further configured to determine a second pattern of purchasing activity for the first user based on the purchase history information, the second pattern comprising a lack of use of a specified payment mechanism; and
the recommendation generation module is further configured to:
generate a second recommendation for the first user based on the determined second pattern of purchasing activity, the second recommendation comprising a payment recommendation for the specified payment mechanism; and
cause the second recommendation to be presented to the first user on the first computing device.

7. The system of claim 6, wherein the payment recommendation is configured to enable the first user to create an electronic payment account for the specified payment mechanism.

8. The system of claim 1, wherein the recommendation generation module is further configured to generate a second recommendation based on the purchase history information, the second recommendation comprising a compliment product recommendation corresponding to at least one product that is configured to be used in conjunction with at least one previously-purchased product identified in the purchase history information.

9. A computer-implemented method comprising:
receiving user input identifying at least one account of a first user, each one of the at least one account being hosted by a corresponding online service independent of a first website;
establishing a link with the at least one account of the first user based on a user-generated interrupt corresponding to the user input;
accessing purchase history information of the first user from the at least one account of the first user;
determining, by at least one processor, a first pattern of purchasing activity for the first user based on the purchase history information;
generating a first recommendation for the first user based on the determined first pattern of purchasing activity, the first recommendation comprising a first content of the first website;
determining a presentation time for the first recommendation based on the determined first pattern of purchasing activity; and
causing the first recommendation to be presented to the first user on a first computing device at the determined presentation time.

10. The method of claim 9, wherein the at least one account comprises at least one of an e-mail account of the first user, a credit card account of the first user, and an e-commerce account with an e-commerce website.

11. The method of claim 9, wherein determining the pattern of purchasing activity comprises:
identifying repeated purchases of a same type of product based on the purchase history information;
calculating a frequency of the repeated purchases;
determining that the frequency of the repeated purchases satisfies a predetermined threshold value; and
determining that the first pattern of purchasing activity comprises the repeated purchase of the same type of product.

12. The method of claim 11, wherein the first recommendation comprises a product recommendation of the same type of product on the first website, and the presentation time for the first recommendation is based on the frequency of the repeated purchases.

13. The method of claim 9, further comprising:
determining a second pattern of purchasing activity for the first user based on the purchase history information, the determining comprising identifying repeated purchases of a same type of product based on the purchase history information;
determining a category for the same type of product;
generating a second recommendation for the first user based on the determined second pattern of purchasing activity, the second recommendation comprising a product recommendation for a product of the category on the first website; and
causing the second recommendation to be presented to the first user on the first computing device.

14. The method of claim 9, further comprising:
determining a second pattern of purchasing activity for the first user based on the purchase history information, the second pattern comprising a lack of use of a specified payment mechanism;
generating a second recommendation for the first user based on the determined second pattern of purchasing activity, the second recommendation comprising a payment recommendation for the specified payment mechanism; and
causing the second recommendation to be presented to the first user on the first computing device.

15. The method of claim 14, wherein the payment recommendation is configured to enable the first user to create an electronic payment account for the specified payment mechanism.

16. The method of claim 9, further comprising generating a second recommendation based on the purchase history information, the second recommendation comprising a compliment product recommendation corresponding to at least one product that is configured to be used in conjunction with at least one previously-purchased product identified in the purchase history information.

17. A non-transitory machine-readable storage medium storing a set of instructions that, when executed by at least one processor, causes the at least one processor to perform operations comprising:
receiving user input identifying at least one account of a first user, each one of the at least one account being hosted by a corresponding online service independent of a first website;
establishing a link with the at least one account of the first user based on a user-generated interrupt corresponding to the user input;
accessing purchase history information of the first user from the at least one account of the first user;
determining a first pattern of purchasing activity for the first user based on the purchase history information;
generating a first recommendation for the first user based on the determined first pattern of purchasing activity, the first recommendation comprising a first content of the first website;
determining a presentation time for the first recommendation based on the determined first pattern of purchasing activity; and
causing the first recommendation to be presented to the first user on a first computing device at the determined presentation time.

18. The storage medium of claim 17, wherein the at least one account comprises at least one of an e-mail account of the first user, a credit card account of the first user, and an e-commerce account with an e-commerce website.

19. The storage medium of claim 17, wherein determining the pattern of purchasing activity comprises:
identifying repeated purchases of a same type of product based on the purchase history information;
calculating a frequency of the repeated purchases;
determining that the frequency of the repeated purchases satisfies a predetermined threshold value; and
determining that the first pattern of purchasing activity comprises the repeated purchase of the same type of product.

20. The storage medium of claim 19, wherein the first recommendation comprises a product recommendation of the same type of product on the first website, and the presentation time for the first recommendation is based on the frequency of the repeated purchases.
